(19) United States
(12) Patent Application Publication
(10) Pub. No.: US 2009/0327465 A1
(43) Pub. Date: Dec. 31, 2009

(54) Distributed Configuration Orchestration for Network Client Management

(75) Inventors: Brett D. A. Flegg, Redmond, WA (US); Michael J. Healy, Duvall, WA (US); Shafqat Ullah Khan, Lynnwood, WA (US); Sean Andrew Cannella, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/147,483

(22) Filed: Jun. 27, 2008

(51) Int. Cl. G06F 15/173

(52) U.S. Cl. 709/223

(57) ABSTRACT

Described is a network configuration management technology in which an orchestration point coordinates client machines and/or other machines to each run an activity with respect to the client machines to perform management tasks. The orchestration point controls the start of the activity. A management point and server may report progress. The orchestration point coordinates running the activities, e.g., serially or in parallel among the clients, and/or based on percentage of total machines allowed to simultaneously run an activity and/or current workload. Activities may include a task sequencing activity, a desired configuration management activity, a command set-related activity and/or a custom activity generated from a script, e.g., a PowerShell™ script. Also described is a replicator activity, which may be limited (e.g., based on a percentage of the total machines) and/or throttled (e.g., based on current load).

### BACKGROUND

Many products exist to help manage network clients. For example, poll-based policy management solutions (e.g., Microsoft Corporation's System Center Configuration Manager 2007) have proven very successful when managing a large number of desktop clients. However, it has become increasingly apparent that there is a need for a reliable, scalable, and secure mechanism to directly interact with client machines and coordinate operations across multiple machines.

For example, in both the server and client management space there is a need for administrators to be able to respond quickly to client requests, including Helpdesk/incident response requests, requests for new software, and so forth. This is difficult to coordinate with traditional poll-based management solutions.

As another example of where better coordination is needed, consider clusters of server machines, which are used to increase the reliability and scalability of the services they host. When executing management operations on clusters (such as applying software updates) it is often necessary to coordinate operations (such as reboots) on individual nodes so that the integrity of the cluster is maintained. Datacenters also require such coordination, because one machine may affect many thousands of people that rely on a service provided by that machine. Reliability is thus important, and any mechanism to improve coordination and/or track management operations is desirable.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which an orchestration point coordinates management tasks, such as activities run on a client machine or run elsewhere, (e.g., running on the orchestration point). The orchestration point controls the start of a management task. A management point may be provided to receive status messages from the clients with respect to that client's progress in executing the task. A management server outputs progress reports based on the status messages.

In one aspect, the orchestration point coordinates running at least one activity corresponding to the management task, including by running activities serially or in parallel among the clients. The orchestration point also may coordinate running an activity on one or more clients and elsewhere, that is, on a non-client machine or multiple machines, one of which may include the orchestration point itself. For example, an activity to submit a hardware procurement request may be run on the orchestration point itself. Further, a “control flow” activity may be run, such as a replicator activity (described below), in which subtasks are created and state is managed inside the workflow host.

For parallel operation, the orchestration point may control how many client machines (e.g., as a percentage of the total machines) can run the activity at the same time, and/or based how loaded the client machines currently are, e.g., based on a throttling parameter. In one aspect, activities may include a task sequencing activity, a desired configuration management activity, an activity corresponding to running a command set (one or more commands) and/or a custom activity generated from a script, e.g., a PowerShell™ script, Jscript, VBScript or the like. An activity may also use management tools such as VBScript or Windows Management Interface (WMI).

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is block diagram showing various components and data flow in a distributed configuration orchestration environment.

FIG. 2 is a representation of an example workflow created to deploy a three-tier web application

FIG. 3 is an example implementation of distributed configuration orchestration incorporated into a system center configuration manager environment.

FIGS. 4-6 are flow diagrams representing example steps taken by a server, client and sequencing task, respectively, to run a management task on a client.

FIG. 7 is a diagram representing information exchanged between a server, sequencing task and client when executing a task sequence activity.

FIG. 8 is a class diagram showing an example of how a dynamic activity is created.

FIG. 9 is a block diagram providing an example of how an enhanced replicator activity may be used to patch servers of a server cluster.

### DETAILED DESCRIPTION

Various aspects of the technology described herein are generally directed towards a distributed configuration management solution, which provides various orchestration features and characteristics that are desirable in network client management. As will be understood, such features and characteristics include near real-time status that quickly provides an administrator with status feedback so that the administrator can take appropriate action. The technology provides for distributed parallel execution, allowing multiple activities to run at the same time, while providing a mechanism to synchronize activities that are running on the distributed systems. The orchestration solution also allows for distributed tasks to interact with users when appropriate, such as by providing notification of events, requests to execute manual steps (e.g., connect a machine), and/or seek authorization for a specific action.

Further, the orchestration solution described herein works in long running scenarios, such as automated tasks that can take days or weeks to complete, e.g., ordering a new server via procurement procedures, which when received also needs to be installed). Failures (hardware/software/human) that happen during the execution of distributed tasks are handled, e.g., via mechanisms to recognize and compensate (e.g. rollback) for failures.

Other aspects including handling cancellation requests, such as received from an administrator, or because of a failed step in a workflow that causes the workflow to cancel other running actions. Service windows are supported to allow planned servicing; tracing and debugging are also supported. Cross Platform Support is also facilitated.

It should be understood that any examples set forth herein are non-limiting examples. For example, an exemplified orchestration solution is primarily implemented on Windows®-based machines, and in one implementation is described as being integrated into an existing technology, but the technology described herein may be implemented on other operating systems. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and network management in general.

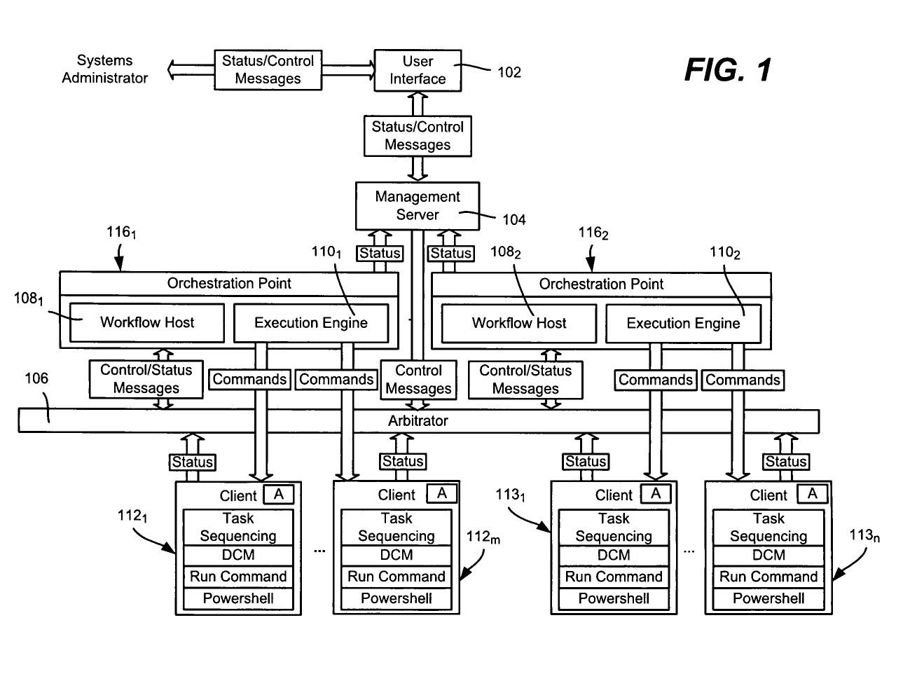

As generally represented in FIG. 1, there is shown a network environment in which various aspects of the orchestration solution are described. Components in FIG. 1 include a user interface 102 that provides systems administrators with a mechanism to create, edit, and debug routines. The interface 102 also provides a mechanism to schedule, track, and control (start/stop) workflow routines and to manage collections of resources. This input and output data is represented by the status/control messages, including to and from a management server 104 infrastructure (such as ConfigMgr) that manages content, schedules, machine inventory, groups, and settings.

In order to balance workloads across multiple machines (for scalability and reliability) an arbitrator 106 is provided that is responsible for assigning workloads to specific servers, monitoring performance, and forwarding commands/messages to suspended workflows.

A workflow runtime executes workflows, such as to manage state, control messages and so forth, which in one implementation is based on Windows Workflow Foundation. Such runtimes are hosted on a workflow host, represented in FIG. 1 via the workflow hosts 108₁ and 108₂. An execution engine exposes a set of primitive operations (such as “Run PowerShell™ Script”) to workflow activities. Two execution engines 1101 and 1102 are shown in FIG. 1; each manages the communication with agents on client machines 112₁-112ₘ and 113₁-113ₙ and notifies its respective workflow host 108₁ or 108₂ when the operation is complete. Together, each workflow host, execution engine pairing may be considered part of an orchestration point, 116₁ or 116₂; while two are shown in FIG. 1, it is understood that there may be any practical number in a given implementation.

A client agent (represented by the box “A” on each client machine 112₁-112ₘ and 113₁-113ₙ) is installed on each managed client machine, e.g., a desktop computer, laptop computer, workstation, or the like. When a client agent receives a command from the execution engine it performs the operation on the client machine and reports status back to the server infrastructure. Note that the code that otherwise may be run by a client agent may instead be moved to a remote machine for purposes of execution.

Note that workflow activity does not necessarily need to run on the client. It may be “client agnostic” or the like, such as an activity to submit a hardware procurement request, in which event it is run on the orchestration point itself. It may also be a “control flow” activity, like a replicator activity (described below), in which case subtasks are created and state is managed inside the workflow host.

Clients may also include built-in workflow activities developed specifically to enable management scenarios. For example, each client includes a task sequencing activity for automating a series of actions on client machines; (note that task Sequences are a mechanism developed in System Center Configuration Manager 2007). An execute task sequence workflow activity can be used to run and track a task sequence on a client machine to perform tasks such as deploying an operating system.

Another activity applies a desired configuration management (DCM) model to machines. A run command primitive is also shown for use in accomplishing management tasks.

PowerShell™ activity generation is a mechanism related to generating custom activities. More particularly, this mechanism provides a way for non-developers to add new activities, by automatically generating a workflow activity from a PowerShell™ script so that administrators can easily automate tasks.

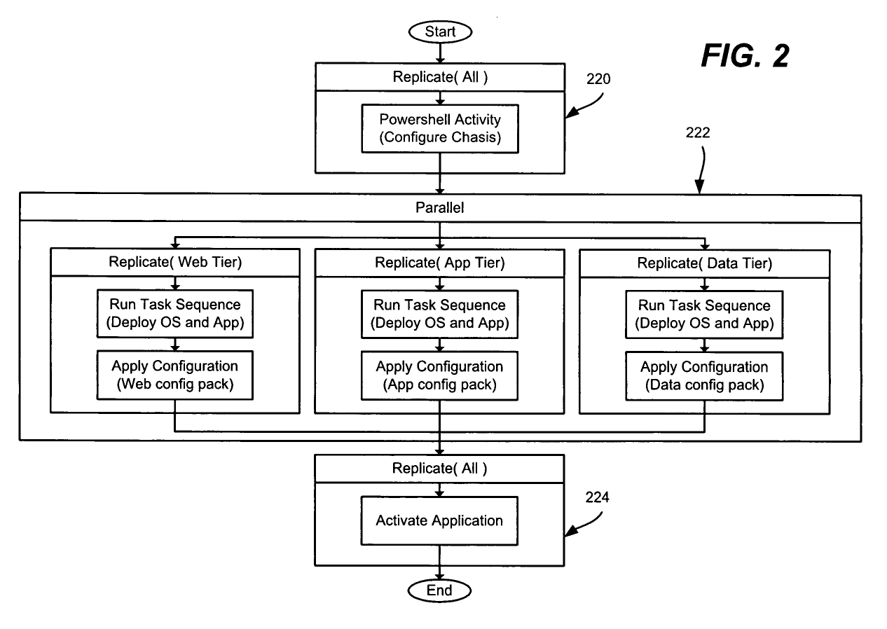

In one implementation, this framework is used to automate various administrative tasks, including those described above. By way of example, consider the example workflow of FIG. 2, which is directed towards deploying a simple three-tiered web service. An administrator starts by defining groups of machines and defining appropriate machine and collection variables (for example the IP address of a machine). The administrator then creates images, OS deployment task sequences, configuration packs, and other content/scripts needed to support the deployment of the service. These operations, which may be performed at least in part in a PowerShell™ activity, are represented by the block labeled 220.

The administrator uses a workflow editor or the like to combine these objects to create a reusable deployment routine. The deployment routine may be replicated and run in parallel (block 222). The administrator may then use the UI 102 to schedule and track the execution of the deployment routine, and then ultimately activate the application (block 224) to provide the service.

To summarize thus far, the distributed configuration orchestration solution facilitates simplicity of authoring, such as via a drag-and-drop interface that allows an administrator to author a reusable routine to automate system maintenance tasks across multiple machines, (e.g., provisioning the three-tiered web application), using simple building blocks including PowerShell™ scripts, task Sequences, and desired configuration models. For example, routines may be assembled by dragging and dropping “building block” activities into an “interactive flow chart,” such as in Microsoft Corporation's Visual Studio workflow authoring environment.

Further, Windows Workflow Foundation provides a mechanism to link together a series of actions. The orchestration solution of FIG. 1 extends this to include a client/server piece that enables the automation/coordination of tasks on multiple machines. At the same time, workflow activities are easily generated via PowerShell™ scripts.

Moreover, the integration of Windows Workflow and task sequences is provided, via the mechanism to execute and track task sequences using Windows Workflow. This makes it possible to combine the efficiencies of client-side execution and the control and feedback provided by server-side-based automation solutions. The extended task sequence environment provides a simple mechanism to share data between sequential activities in a network. Also described is the integration of Windows Workflow and Desired Configuration Management, which makes it possible to automate the configuration of a service as part of the deployment process. A replicator activity allows performing similar operations on multiple machines; while—Windows Workflow Foundation introduced a replicator activity, the orchestration solution described herein extends replication and integrates it with the concepts of System Center Configuration Manager collections and machine variables to provide a useful mechanism to perform a series of parameterized actions on a set of machines. Further, the orchestration engine is based on the Windows Workflow Foundation hosting model, which makes it possible to achieve scalability and reliability using multiple machines.

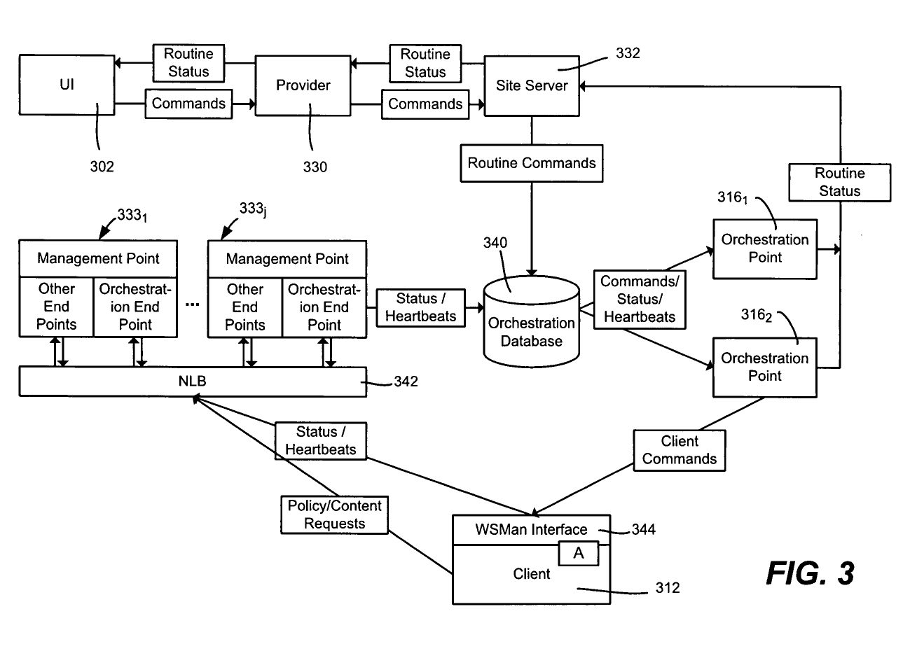

FIG. 3 shows an implementation of a distributed configuration orchestration solution built on existing System Center Configuration Manager technology, which provides a scalable and reliable infrastructure on which to execute management routines. In one example implementation, the system center's admin UI 302 is used as a user interface for the orchestration solution. ConfigMgr objects, such as system resources, collections, packages, and machine/collection variables comprise objects that can be manipulated by orchestration routines.

The provider 330, site server 332, management points 333₁-333ⱼ, and orchestration (distribution) points 316₁ and 316₂ (corresponding to orchestration points 116₁ and 1162 of FIG. 1) make up the core of one example management server infrastructure. Consistent with FIG. 1, but not shown in FIG. 3 for purposes of clarity, each orchestration point (server) 3161 and 3162 includes the role of hosting the workflow host runtime and the execution engine.

In this particular implementation, an orchestration database 340 is used as a mechanism to schedule workflows and control their execution, (whereby no specific arbitrator component is needed). When one of the management points 333₁-333ⱼ receives status messages from a client 312, that management point writes these into the orchestration database 340, such as to notify the corresponding workflow to resume executing. Note that in general, a management point 333₁-333ⱼ is selected for client communication based upon network load balancing (NLB) 342.

With respect to the client 312 and its agent, in this example implementation, an enhanced version of the System Center Configuration Manager's ConfigMgr client is used to coordinate execution on the client. It hosts a WSMan interface 344 with which the execution engine communicates to initiate commands. Note that the client agent can download policy and content from the existing server infrastructure, and it reports status back to the management point.

Turning to various aspects of task sequence activities, as mentioned above, System Center Configuration Manager 2007 introduced a new workflow-type technology referred to as task sequencing. Task sequences were designed with operating system deployment in mind, and in general have the ability to execute a series of tasks across multiple reboots and even multiple operating systems. Task sequences are also useful to customers that need to automate other tasks on a single machine (e.g., like installing an application and a set of service packs).

The execution state of task sequences is maintained on the client side. Once started, they run independently of the server infrastructure (although they can report status back to the server). Therefore, it is possible to run a large number of task sequences concurrently without consuming many server-side resources.

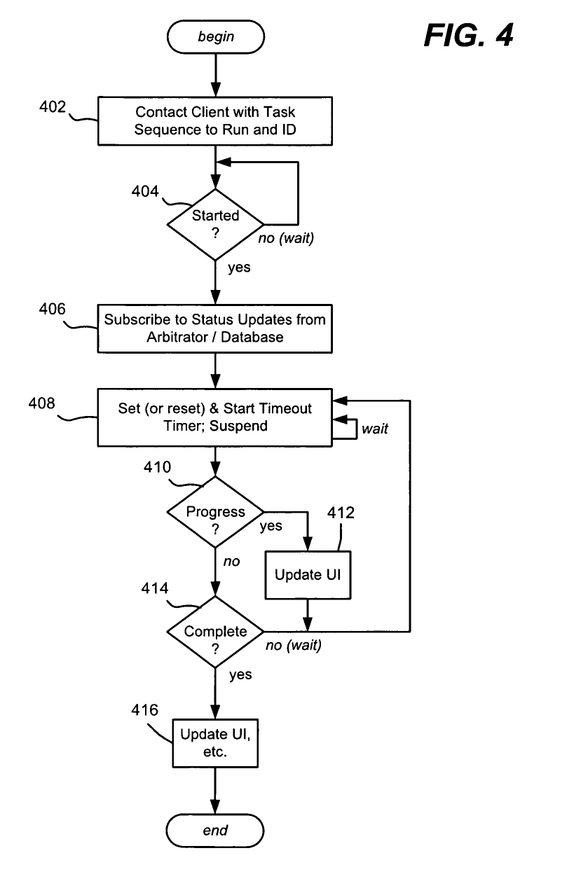

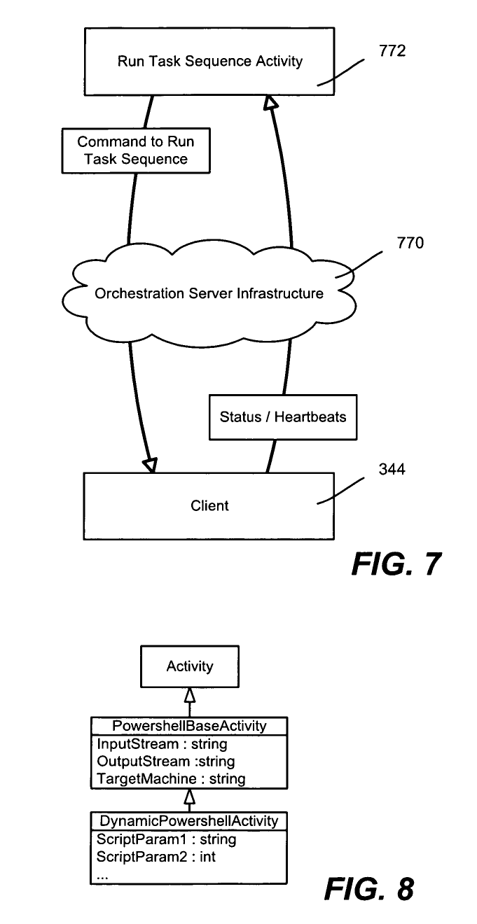

When executed in a distributed environment such as represented in FIGS. 1 and 3, a run task sequence activity uses the orchestration infrastructure (e.g., via orchestration point 316₂) to contact the client 312 and provide it with the definition of the task sequence to run, along with a particular ID that is used for tracking the progress of the task sequence, as generally represented at step 402 of FIG. 4. Note that FIGS. 4-6 provide flow diagrams representing operations of the orchestration infrastructure (server), client and sequence activity, respectively; note that while some of the waits and the like are shown as loops for purposes of explanation, it is understood that these may be event driven rather than actual looping. FIG. 7 shows how an example client 312, orchestration infrastructure 770 and run task sequence activity 772 interact, e.g., via commands, status and heartbeats.

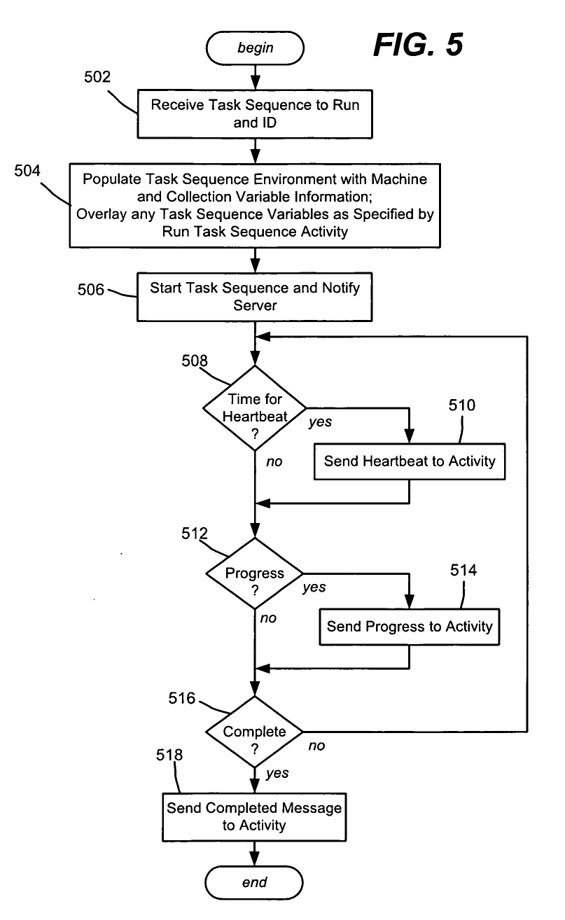

When the client 312 receives the instruction to run a task sequence, as represented by step 502 of FIG. 5, the client resolves any content associated with the task sequence. Note that in one alternative, the orchestration infrastructure may provide this information before the task sequence starts and/or the task sequence infrastructure may resolve the content only when needed.

At step 504, the client 312 populates the task sequence environment with machine and collection variable information for the machine, and then overlays any task sequence variables specified by the run task sequence activity. As generally represented by step 506, the client 312 starts the task sequence and notifies the server infrastructure 770 that the task sequence has successfully started.

As generally represented by step 404 of FIG. 4, once the server has confirmed that the task sequence has been successfully started, the server subscribes to status updates from the arbitrator (or database) at step 406. At step 408 the server also sets (or resets after the initial set) and starts a timeout timer and then is suspended; for purposes of brevity, evaluation of the server's timeout timer is not shown in FIG. 4, but as understood, allows the server to cancel the activity in the event of failures and the like.

Returning to FIG. 5, while executing the task sequence, the client sends messages to the activity 772 directed towards the server infrastructure 770, including status messages that indicate the success/failure of each step in the task sequence, and periodic heartbeats to indicate the client is still online and functioning correctly. These messages are represented by steps 508, 510, 512 and 514.

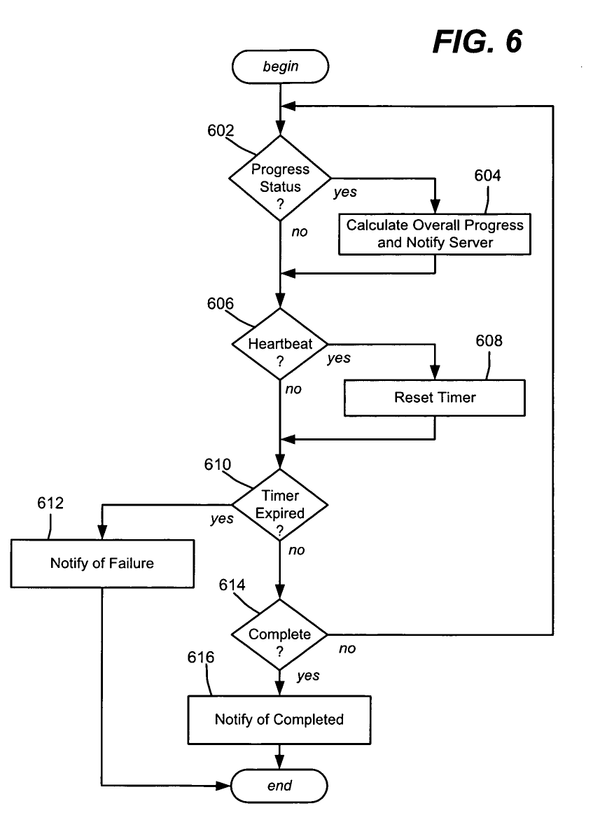

As represented in FIG. 6, while waiting for the task sequence to complete (step 614), the activity 772 handles progress status messages (steps 602 and 604). For example, when the activity 772 receives progress status messages from the client, the activity 772 calculates the overall progress of the task and notifies the server infrastructure 770 so the progress can be updated in the server UI (steps 410 and 412).

When the activity 772 receives a heart-beat message from the client (step 606), the activity 772 resets the timeout timer (step 608). If the timeout time expires (step 610, e.g., a heartbeat message was not received in time) the workflow runtime is notified of the failure via step 612.

At step 614, when a completion message (success or failure) is detected, the activity 772 completes and notifies the server infrastructure workflow runtime of the result where it can take appropriate action, such as to update its UI, close the task, and so forth. This is represented via steps 516 and 518 of FIG. 5 (client), steps 414 and 416 of FIG. 4 (server), and steps 614 and 616 of FIG. 6 (activity).

The desired configuration management (DCM) activity works similar to the task sequence activity. However, instead of passing a set of explicit instructions for the client to execute, the server provides the client with desired configuration policy. The client has a policy processing engine that executes the instructions necessary to move the client to a desired state.

In general, systems administrators are more comfortable writing scripts than writing code. Thus, there is provided a mechanism to automatically generate Windows Workflow Activities from PowerShell™ scripts so that Administrators can easily automate administrative tasks.

To this end, a Workflow editor or the like has a “Create Activity from PowerShell™ script” option that launches a Wizard and prompts the administrator/script author to select an existing PowerShell™ script; (it is feasible for this technique to work with other scripting languages like VBScript). The script is then scanned for input/output parameters. These are then presented to the administrator to verify and annotate (e.g., add help descriptions).

Then, a new activity is created. For example, the dynamic code generation capabilities of .NET may be used to derive a new activity from an existing Workflow activity base class (that exposes a set of common PowerShell™ script parameters such as target machine, input stream, and output stream). The script parameters are exposed as workflow activity properties in the new script. The script itself is encoded in the activity so that it can be accessed when the activity is executed (an alternative is to encode a reference to the script instead).

Methods are generated to marshal the parameters and call the PowerShell™ script when the activity is executed. The activity is compiled and added to the global activity library so that it can be used in any workflow routine.

FIG. 8 shows the class hierarchy for a dynamic PowerShell™ activity. The base class defines a set of default parameters that are used by the PowerShell™ activities (including input stream, output stream, and target machine).

Later, when the activity is executed, Windows Workflow Foundation marshals the parameters and calls the Activities Execute method. This includes verifying the parameters and creating a command line to call the PowerShell™ script (it may also use the PowerShell™ SDK). Further, this launches PowerShell™ and tracks the progress of the script. When complete, the output stream is encoded and returned as an out parameter.

As also described above, Windows Workflow Foundation provides the concept of a replicator activity that can be used to create a number of instances of a child activity based on a provided data set; (a replicator can be basically considered as a type of “for each” loop for workflows). The replicator activity may be configured (e.g., as subtasks) to run the instances serially or in parallel.

This activity can be enhanced for use in server management including by passing machine grouping information as the set of objects from the management server to the replicator. Child activities can then access machine variable information as needed. This way, the replicator can be used to perform a series of tasks on a group of machines.

Further, the option to run child instances serially or in parallel can be enhanced to allow a certain percentage of instances to execute at once. For example, it is possible to configure a replicator to execute at most twenty percent of the total instances at a given time. This type of configuration can be extremely useful when performing operations such as applying software updates on machines in a clusters (since it is important to ensure the service provided by the cluster is always available).

Still further, the current load/health of a service can be used when determining the number of instances to run in parallel. For example, it would be possible to configure the enhanced replicator activity to throttle the number of instances created when the service is under heavy load.

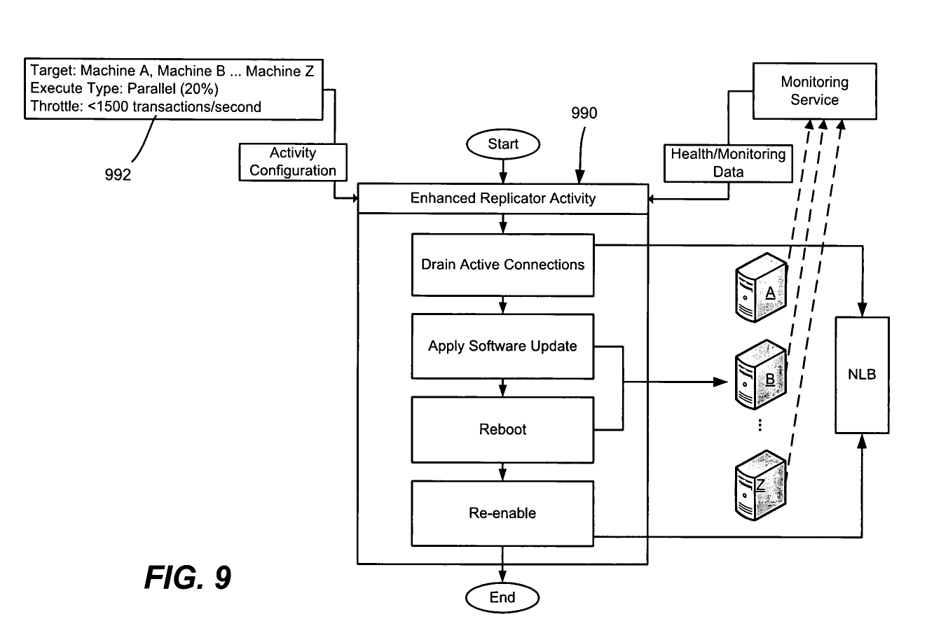

By way of example, a workflow can be built using the enhanced replicator activity to perform activities such as applying software updates to a cluster as represented in FIG. 9. For example, FIG. 9 shows how the orchestration-enhanced replicator activity 990 can be used to patch a cluster of machines (Machines A-Z).

In general, the parameters 992 for the activity configuration are set such that the target machines are Machines A-Z, with execution set for parallel execution but limited to 20 percent. The throttling variable is set to less than 1500 transactions per second. Note that health monitoring data is collected by a monitoring service 994 and fed to the replication activity 990.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a system comprising:
an orchestration point; and
a plurality of client machines coupled to the orchestration point, the orchestration point coordinating at least one management task with respect to managing the client machines.

2. The system of claim 1 wherein each client includes a client agent coupled to the orchestration point to run a management task via an activity on each client machine, the orchestration point controlling the start of the activity run by each client agent.

3. The system of claim 1 wherein the orchestration point coordinates at least one management task by controlling the start of an activity run on a machine that is a remote machine relative to at least one client being managed.

4. The system of claim 1 wherein the orchestration point comprises a workflow host that hosts a workflow runtime corresponding to the task and an execution engine that exposes operation to the workflow activity.

5. The system of claim 1 wherein the orchestration point coordinates running the management task, including running tasks serially by starting the management task on one client machine after completion of the management task on another client machine.

6. The system of claim 1 wherein the orchestration point coordinates running the management task, including running tasks at least partially in parallel by starting the management task on one client machine before completion of the management task on another client machine.

7. The system of claim 1 wherein the orchestration point coordinates running the management task on each client machine, including by determining when to start a management task on a machine based on a parameter that corresponds to how many machines may run the management task in parallel.

8. The system of claim 1 wherein the orchestration point coordinates running the management task on each client machine, including by determining when to start a management task on a machine based on a throttling parameter that corresponds to a current system load.

9. The system of claim 1 wherein the activity comprises a task sequencing activity, a desired configuration management activity, an activity corresponding to a command set, or an activity generated from a script.

10. The system of claim 1 wherein the management task corresponds to a replicator activity.

11. The system of claim 1 wherein the orchestration point is coupled to the client machines via an arbitrator or a database to assign workloads to servers, monitor performance, or forward commands or messages or both commands and messages to suspended workflows, or any combination of assigning workloads, monitoring performance, or forwarding commands or messages or both commands and messages.

12. The system of claim 1 further comprising a management server coupled to one or more of the client machines to output progress information based on received status information.

13. The system of claim 12 further comprising a management point, wherein the management server is coupled to the one or more client machines via the management point.

14. The system of claim 13 wherein the management point receives heartbeat messages from each client coupled thereto.

15. In a computing environment, a method comprising, coordinating activity instances of an activity across each of a plurality of client machines, including, for each activity instance, controlling a start of the activity, subscribing for status updates corresponding to the activity, receiving status updates, updating progress information based on a status updated that provides progress information, and completing the activity based upon a status update that indicates completion.

16. The method of claim 15 wherein the activity corresponds to a task sequence activity, and wherein receiving the status updates comprises receiving notifications from the task sequence activity based on status messages obtained by the task sequence activity from the client.

17. The method of claim 15 wherein coordinating the activity instances comprises, controlling how many client machines are running the activity at the same time based on an input parameter, or controlling how many client machines are running the activity at the same time based on a load parameter versus current load data, or both controlling how many client machines are running the activity at the same time based on an input parameter and based on a load parameter versus current load data.

18. In a computing environment, a system comprising:
an orchestration point;
a plurality of client machines coupled to the orchestration point, the orchestration controlling the start of an activity run with respect to each client machine; and
a management point coupled to receive status messages corresponding to progress in executing the activity with respect to at least one client.

19. The system of claim 18 wherein the activity is run on a client agent of the client machine or on a remote machine relative to the client machine, and wherein the orchestration point coordinates running the activity, including controlling how many client machines the activity applies to at a same time based on an input parameter, or controlling how many client machines the activity applies to at the same time based on a load parameter versus current load data, or both controlling how many client machines are running the activity at the same time based on an input parameter and based on a load parameter versus current load data.

20. The system of claim 18 wherein the activity is run on a client agent of the client machine or on a remote machine relative to the client machine, the activity comprising a task sequencing activity, a desired configuration management activity, an activity corresponding to running a command set, or a custom activity generated from a script, or any combination of a task sequencing activity, a desired configuration management activity, an activity corresponding to running a command set, or a custom activity generated from a script.
